(19) United States
(12) Patent Application Publication
(10) Pub. No.: US 2008/0286483 A1
(43) Pub. Date: Nov. 20, 2008

(54) Multi-Colour Printing

(75) Inventors: Nazir Khan, Nottingham (GB); Christopher Anthony Wyres, Cheshire (GB)

Correspondence Address: SALIWANCHIK LLOYD & SALIWANCHIK;A PROFESSIONAL ASSOCIATION, PO BOX 142950, GAINESVILLE, FL, 32614-2950, US

(73) Assignee: SHERWOOD TECHNOLOGY LTD., Cheshire (GB)

(21) Appl. No.: 11/659,758

(22) PCT Filed: Aug. 17, 2005
(86) PCT No.: PCT/GB05/03222

§ 371 Date: Oct. 1, 2007

(30) Foreign Application Priority Data
Aug. 20, 2004 (GB) 0418676.3
Feb. 28, 2005 (GB) 0504115.7

(51) Int. Cl. C08J 7/04

(52) U.S. Cl. 427/510

(57) ABSTRACT

A method for forming an image on a substrate, which comprises applying to the substrate a combination of a diacetylene and a photoacid or photobase, and polymerising the diacetylene by radiation, is provided. The method finds use in multi-colour printing.

### FIELD OF THE INVENTION

This invention relates to a method for multi-colour printing.

### BACKGROUND OF THE INVENTION

Lasers have been widely used to achieve marking, typically by ablation but also by causing material, that can absorb the laser energy, to char or change colour. Systems of this type, and which can be used on pills, for ingestion, are described in WO02/068205. Another particularly useful marking material is ammonium octamolybdate, as described in WO02/074548.

Polydiacetylene may be coloured. Further, for example, it is known that the blue form of poly(10,12-pentacosadiynoic acid) is transformed to the red form in response to various stimuli, e.g. temperature, pH and mechanical stress. This has been utilised to produce calorimetric chemosensors or biosensors, where the perturbation arises due to binding of a given analyte to a receptor covalently attached as a pendant group to the polydiacetylene backbone. Preference is generally for polydiacetylene structures such a liposomes or Langmuir-Schaefer films.

Diacetylenes can be polymerised by irradiation with UV light. The use of a UV laser to cause the marking of a diacetylene has been described in, for example, U.S. Pat. No. 5,149,617. That document also describes how the polydiacetylene can undergo a thermochromic change, e.g. from magenta to red. Thus, a single UV irradiation step is followed by a separate, heating step.

U.S. Pat. No. 4,705,742A discloses differential exposure of a conjugated polyacetylenic compound, to develop a range of colours in a layer on a substrate. The irradiation is with an election beam, at a wavelength below 200 nm.

### SUMMARY OF THE INVENTION

The present invention is based in part on an application of how the effects reported in U.S. Pat. No. 4,705,742A can be controlled, and utilised to achieve effective multi-colour printing. This invention utilises the realisation that polydiacetylenes typically exhibit a colour (which, for the purposes of this specification, includes shades of colour) dependent on the degree of polymerisation. Thus, by controlling the degree of polymerisation of a diacetylene, a variety of colours from blue through to red and possibly even yellow can be produced. In other words, multi-colour printing can be achieved simply and specifically, especially by using one or more UV lasers.

In particular, it has been found that the blue to red colour change can be induced by exposure of films of poly(pentacosadiynoic acid) to simple amines. The colour change is apparently driven by twist induced by quaternisation of carboxylic acid/amine, leading to steric or repulsive effect of charged species. The effect of quaternisation is distinct from the known thermochromic response, as it involves chemical modification of the polymer, whereas the thermochromic response simply involves reorientation of the polymer chains by heating. Thus, a simple laser imaging system may comprise either a carboxylic acid-functionalised polydiacetylene or an amine-functionalised polydiacetylene, in combination with either a photobase or photoacid, respectively. Exposure of the films to a laser (UV, Vis, NIR, CO₂) results in generation of amine or acid, which reacts with the respective polymer-bound functionality, causing blue to red colour change. The degree of colour change can be modulated by the intensity of the laser, and consequently composite colours can be generated. It may be particularly useful that effects can be achieved outside the UV range.

Advantages of the present invention include the use of a precursor (diacetylene) that may be colourless and commercially available. The desired effect can be achieved by solid-state polymerisation, giving a colour dependent on the conjugation length. This can be controlled by controlling the degree of polymerisation, and also by the exertion of torque on the polymer backbone. Polydiacetylenes are generally non-toxic, and can therefore be used for marking on pills and other ingestible formulations.

While a diacetylene may be colourless or transparent in its monomeric state, a wide range of colours can be obtained from a single precursor. The fluence level required to induce colour change may be low, allowing high marking speeds to be obtained. “Cold-marking” and excellent image fixing can be achieved.

### DESCRIPTION OF PREFERRED EMBODIMENTS

The colour of polydiacetylenes and the fact that this varies according to the degree of polymerisation, is apparently a property associated with these polymers in general. Accordingly, a wide variety of diacetylenes can be used in the invention. Many are available or have been described; see, for example, U.S. Pat. No. 3,501,303A and U.S. Pat. No. 4,705,742A, the contents of which are incorporated herein by reference.

Diacetylenes can be readily formulated in a solvent or water-based ink and coating compositions and applied to any suitable substrate. Suitable organic solvents are known to those of ordinary skill in the art and include ketones such as methyl ethyl ketone, esters such as ethyl acetate, alcohols, alkyds, hydrocarbons such as toluene or xylene, polar aprotic solvents such as dimethyl sulphoxide or N,N-dimethylformamide, and chlorinated solvents such as dichloromethane, chloroform or dichloroethane. Suitable binders are known to those of ordinary skill in the art and include acrylics, methacrylics, styrenics, alkyds, polyesters, cellulosics, polyethers and polyurethanes. Suitable substrates are known to those of ordinary skill in the art and include papers, polyethylene, polypropylene, polyesters and metals such as aluminium or steel.

The wavelength of the light required to induce polymerisation is dictated by the spectral sensitivity of the diacetylene. This material must exhibit significant absorbance at the given wavelength to make the process suitably efficient and consequently, practicable and commercially viable. By way of example, its diffuse reflectance spectrum indicates that 10,12-pentacosadiynoic acid exhibits appreciable absorbance only at wavelengths shorter than 310 nm, and that light of this wavelength or shorter is required to induce polymerisation.

It has been found that the addition of photoacid generators sensitises the polymerization of diacetylenes to longer wavelengths beyond the intrinsic absorption of the diacetylene, and corresponding to the absorption of the photoacid generator. Given the nature of diacetylene polymerisation, this result is entirely unexpected; photoacid generators generate super-acids upon irradiation, species which are not known to affect polymerisation of diacetylenes. By means of the invention, it is possible to induce polymerisation of 10,12-pentacosadiynoic at wavelengths beyond its intrinsic absorbance, e.g. 365 nm, 405 nm etc.

Suitable photoacids and photobases are known to those of ordinary skill in the art. Examples are diphenyl iodonium salts (e.g. diphenyliodonium hexafluorophosphate, diphenyliodonium hexafluoroantimonate, diphenyliodonium triflate, diphenyliodonium perfluoro-1-butanesulphonate, diphenyliodonium p-toluenesulphonate; and derivatives thereof), triarylsulphonium salts (triphenyl sulphonium hexafluorophosphate, triphenyl sulphonium hexafluoroantimonate, triphenyl sulphonium triflate, 2-Naphthyl diphenylsulphonium triflate, (4-methoxyphenyl)diphenylsulphonium triflate, (4-phenylthiophenyl)diphenylsulphonium triflate; and derivatives thereof), thiobis(triarylsulphonium) salts (e.g. thiobis (triphenyl sulphonium hexafluorophosphate), thiobis(triphenyl sulphonium hexafluoroantimonate), thiobis(triphenyl sulphonium triflate); and derivatives thereof) and mixtures thereof.

It will be evident that known materials can be used in the invention, and that the invention can be put into practice using known sources of irradiation, although UV lasers are preferred. A single tunable laser may be used in order to induce different degrees of polymerisation in selected areas of the material being treated. Alternatively, a number of different lasers may be used, depending on the circumstances. It will be readily apparent to one skilled in the art that the system can be finely controlled, e.g. under computer control, in a manner which allows defined colours to be obtained in defined areas of the substrate.

The range of colours (including shades) that can be obtained by means of the invention is wide, although it may be found that colours towards the red end of the spectrum are more difficult to obtain. A red colour can be obtained by utilising the thermochromic properties of the polydiacetylene, if desired. Alternatively, since it may often be desirable to avoid the possibility of thermochromic effects, steps can be taken in order to minimise the effect of temperature, and rely on the degree of polymerisation for colour control.

For example, diacetylene formulations having enhanced UV stability are provided by addition of an amine molybdate (see WO04/043704). Such compositions were unimaginable under conditions similar to those utilised for conventional diacetylene/binder formulations. To induce colouration, far greater exposure periods were required. Although the images are clearly visible, the change in optical density is considerably less and hence the contrast is noticeably less than that observed for conventional diacetylene formulations.

It appears that the blue to red colour change in polydiacetylenes arises due to a decrease in conjugation length owing to twisting of the polymer backbone. This transition may be driven by a secondary cross-linking process, other than the primary polymerisation process. The secondary process can be driven by the same UV light source (laser or lamp) utilised for inducing diacetylene polymerisation, or a laser of a different wavelength, e.g. NIR. This will allow direct control over the degree of colour change. It may also aid colour-fastness, by prevention of perturbations arising from thermal or chemical stimuli; the chains will be locked in place by secondary cross-linking. This can be achieved by functionalising diacetylenes with cross-linking groups, e.g. acrylates, methacrylates, epoxides etc.

The following Examples illustrate the invention.

### EXAMPLE 1

Colourless starting material (10,12-pentacosadiynoic acid) in binder (Elvacite 2028, NC, PVB etc) was coated onto substrates (paper, polypropylene, PET, foil) and exposed to UV light (100 W lamp, predominantly 254 nm) for a range of times. The colour produced was dependent upon exposure time/intensity.

The material develops increasingly intense blue colouration and eventually black with increasing exposure time. Lengthening exposure time results in a gradual shift from black through purple to red. A further increase in exposure time results in transformation of the red colouration to a yellow/orange colouration. Prolonged exposure results in degradation of the sample and bleaching of this colour.

Irradiation of the blue or black form of the polymer described above with a low power (<0.5 W) CO₂ laser results in formation of a red image in the exposed area. This is owing to the thermochromic response of the polymer, a well-known phenomenon.

An identical transformation (blue/black-red) to that described immediately above can be induced using a NIR diode (100 mW) laser. However, this requires inclusion of a suitable NIR absorber to convert the laser energy to heat. Copper hydroxyl phosphate (CHP) is one such example. The red markings on the blue background are quite distinct and can be written at relatively high speed, marks being discernible by human eye at up to 50 cm per second.

### EXAMPLE 2

A solution of 1 g of 10,12-pentacosadiynoic acid, 1 g of Cyracure 6974 (photoacid generator) and 8 g of methyl ethyl ketone was prepared. A coating of this mixture was absorbed onto paper by immersing a strip of the substrate in the solution. The coating was then irradiated with a UV lamp having emission centred around 365 nm for 0.2 s, inducing formation of a red colouration in the exposed area, indicating polymerisation had occurred.

A solution of 1 g of 10,12-pentacosadiynoic acid and 8 g of methyl ethyl ketone was prepared. A coating of this mixture was absorbed onto paper by immersing a strip of the substrate in the solution. The coating was then irradiated with a UV lamp having emission centred around 365 nm for 0.2 s. No discernible change occurred, indicating that polymerisation was not induced.

### EXAMPLE 3

A solution of 1 g of 10,12-pentacosadiynoic acid, 1 g of Cyracure 6974 (photoacid generator) and 8 g of methyl ethyl ketone was prepared. A coating of this mixture was absorbed onto paper by immersing a strip of the substrate in the solution. The coating was then irradiated with a UV lamp emitting in the 400-500 nm range for 0.2 s, inducing formation of a blue colouration in the exposed area, indicating polymerisation had occurred. Increasing exposure to 0.5 s resulted in formation of a red colouration.

A solution of 1 g of 10,12-pentacosadiynoic acid and 8 g of methyl ethyl ketone was prepared. A coating of this mixture was absorbed onto paper by immersing a strip of the substrate in the solution. The coating was then irradiated with a UV lamp emitting in the 400-500 nm range for 0.5 s. No discernible change occurred, indicating that polymerisation was not induced.

### EXAMPLE 4

### Coating Formulation

A solution of 1 g of 10,12-pentacosadiynoic acid, 1 g of Cyracure 6974 (photoacid generator), 0.5 g of Elvacite 2028 (acrylic binder) and 8 g of methyl ethyl ketone was prepared. An even coating of this mixture was applied onto paper using a wire-bar coater. The coating was then irradiated with a UV lamp emitting in the 400-500 nm range for 0.5 s, inducing formation of a blue colouration in the exposed area, indicating polymerisation had occurred. Increasing exposure to 1 s resulted in formation of a red colouration.

It will thus be evident that the present invention involves a simple modification that facilitates use of longer wavelength lasers and other light sources for imaging of diacetylenes. Such apparatus is currently more readily available and cost-effective than the shorter wavelength light sources currently required to induce diacetylene polymerisation.

### EXAMPLE 5

### UV Laser Imaging

An ink comprising 6.7 wt % 10,12-pentacosadiynoic acid (PDA) and 23 wt % Elvacite 2028 acrylic binder in methyl ethyl ketone solvent was applied to 50 micron thickness corona treated clear polypropylene using a Mayer bar, giving a coating of approximately 5 g/square metre. After drying, this coating was imaged using a coherent AVIA3000 266 nm diode-pumped solid-state laser coupled to a galvanometer-marking head. The output power and pulse frequency of the laser, as well as the galvanometer marking speed were precisely controlled using a PC/windows based software package. The colour and optical density of the resultant image was found to be dependent upon the fluence of irradiation, results of which are listed below.

0.115 J/cm2—pale blue

0.276 J/cm2—royal blue

0.305 J/cm2—navy blue

0.331 J/cm2—violet

0.625 J/cm2—red

0.717 J/cm2—orange/red

1.953 J/cm2—yellow

Precisely controlling the fluence delivered to each area/pixel of an image allows multicolour images to be prepared.

1. A method for forming an image on a substrate, which comprises applying to the substrate a combination of a diacetylene and a photoacid or photobase, and polymerising the diacetylene by radiation.

2. The method according to claim 1, where the radiation is UV radiation.

3. The method according to claim 1, wherein the diacetylene is polymerised to different degrees in different areas thereof.

4. The method according to claim 3, wherein the polymerising comprises irradiation with a tunable laser.

5. The method according to claim 3, wherein the polymerising comprises irradiation with a plurality of layers under selective control.
